(19) United States
(12) Patent Application Publication
(10) Pub. No.: US 2024/0209912 A1
(43) Pub. Date: Jun. 27, 2024

(54) BELLOWS-TYPE AIR SPRING

(71) Applicant: ContiTech Luftfedersysteme GmbH, Hannover (DE)

(72) Inventors: Bernd Stöter, Laatzen (DE); Paul Huber, Seelze (DE)

(73) Assignee: ContiTech Luftfedersysteme GmbH, Hannover (DE)

(21) Appl. No.: 18/557,710

(22) PCT Filed: Apr. 16, 2022
(86) PCT No.: PCT/DE2022/200067

§ 371 Date: Oct. 27, 2023

(30) Foreign Application Priority Data
Apr. 27, 2021 (DE) 10 2021 204 152.3

(51) Int. Cl. F16F 9/04

(52) U.S. Cl. CPC F16F 9/0445; F16F 2222/126; F16F 2230/0058; F16F 2230/0076

(57) ABSTRACT

A convoluted bellows air spring having at least one belt ring, wherein the convoluted bellows air spring is tiltable about a pivot axis. The invention was based on the object of creating a convoluted bellows air spring for kinematic applications with tiltings, which even in unfavorable situations can nevertheless be operated in conformity with specifications and reliably during tilting of the connection parts, by reliably preventing buckling. This object is achieved in that the belt ring, or if there are a number of belt rings the belt rings, is or are respectively articulated by means of a lever, wherein the articulating pivot axis of the respective lever differs from the pivot axis of the convoluted bellows air spring.

### TECHNICAL FIELD

The invention relates to a convoluted bellows air spring having at least one belt ring, wherein the convoluted bellows air spring is tiltable about a pivot axis.

### SUMMARY

Convoluted bellows air springs having two or more folds have a waist-shaped constriction between the folds. This constriction is formed by a reinforcing ring, which ensures that the elastic rubber bellows does not inflate like a balloon when pressurized. The reinforcing ring is referred to below as a belt ring.

A symmetrical construction of the folds, with reference to the mean cross-sectional plane, ensures symmetrical force ratios in the flexible bellows wall during operation with internal pressure, and therefore, in the event of axial deformation, the two or more folds are “automatically” divided proportionally over the bellows length, provided that the opposite connection parts are arranged symmetrically with respect to one other.

The range of possible axial deformation is limited by the block height as said folds converge, i.e. the height resulting from the sum of the thicknesses of the compressed bellows walls and the belt rings and also the heights of the connection parts, and by the maximum stretching of the textile strength member as said folds move apart.

Convoluted bellows air springs are predestined for applications in which, upon actuation, the fastening surfaces move on a curved path, and therefore the opposite fastening surfaces are inclined at varying angles with respect to one another. For example, these include applications in which the two connection surfaces are connected to each other via a pivot axis. The angling can be greater, the larger the fold. A convoluted bellows air spring having a plurality of consecutively connected folds (“two-fold bellows” or “three-fold bellows”) can in turn realize a multiple of the angling of a single-fold bellows. However, only convoluted bellows air springs having at least two folds and at least one belt ring are considered below.

Air springs of this kind are disclosed, for example, in DE 126 48 78 B or DE 69 61 34 22 T2.

DE 126 48 78 B discloses a convoluted bellows air spring in which the metallic belt rings are designed as separate components: DE 69 61 34 22 T2 describes an embodiment in which the metallic reinforcement consists of a plurality of wound wires which are directly embedded in the elastomer of the convoluted bellows. The belt ring therefore does not constitute a separate component.

If the connection parts of the convoluted bellows air spring are not shifted in parallel during operation, i.e. in the event of angling or tilting, buckling of the convoluted bellows air spring may occur.

Buckling is a malfunction which may lead to an operation not in conformity with specifications, for example, by the specified installation space being exceeded, or by the direction of action of force being shifted by the lateral offset of the belt ring such that the forces are outside the specification. A lateral offset of a belt ring during the convergence may also increase the block size.

In the situations listed here, increased wear or even complete failure of the convoluted bellows air spring generally occurs.

There are therefore attempted solutions to prevent buckling of the convoluted bellows air spring. For example, a simple solution is disclosed in DE 457 626 A, in which one of the belt rings is intended to prevent the convoluted bellows air spring from buckling by using articulated link plates which are hinged on the frame of a vehicle. However, a solution of this kind may not be satisfactory.

FIGS. 3a-3c show the kinematics of a convoluted bellows air spring according to the prior art from DE 475 626 A.

If the guidance described there of belt rings were to be carried out by an articulation 3.7 on the pivot axis 3.6 of the convoluted bellows connection parts 3.4 and 3.5, this would indeed prevent buckling. But, as can be seen in FIGS. 3b and 3c, the convoluted bellows 3.1 would not be able to take up its natural curved longitudinal axis 3.9. The center point 3.3 of the belt ring 3.2 would be shifted by the amount d1 or d2 relative to the curved longitudinal axis 3.9. The articulation of the belt ring still ensures that, when the positions 3.4 and 3.5 are symmetrically constructed, the following applies for the angles: γ1=½×α1 and γ2=½×α2, respectively.

In the event of moving apart to maximum stretching, as shown in FIG. 3c, the usable stroke of the convoluted bellows is reduced by “pushing out” the belt ring by the amount d2.

The invention was based on the object of creating a convoluted bellows air spring for kinematic applications with tiltings, which even in unfavorable situations can nevertheless be operated in conformity with specifications and reliably during tilting of the connection parts, by reliably preventing buckling.

This object is achieved in that the belt ring, or if there are a number of belt rings the belt rings, is or are respectively articulated by means of a lever, wherein the articulating pivot axis of the respective lever differs from the pivot axis of the convoluted bellows air spring, and
in a convoluted bellows air spring having two folds and a belt ring, the intersection of two fictitious auxiliary lines namely defines a first auxiliary line which, in the starting position of the convoluted bellows air spring, is perpendicular to the main axis of the convoluted bellows air spring and, as seen in the axial direction, runs centrally through an adjacent bellows fold,
in a convoluted bellows air spring having three folds and two belt rings, the intersections of three fictitious auxiliary lines namely define a second auxiliary line and a third auxiliary line which, in the starting position of the convoluted bellows air spring, are each perpendicular to the main axis of the convoluted bellows air spring and, as seen in the axial direction, run centrally through the respective outer bellows folds,
with a fourth fictitious auxiliary line which runs parallel to the main axis of the convoluted bellows air spring through the pivot axis of the convoluted bellows air spring.

By means of an articulation of this kind, the articulated belt ring describes or the articulated belt rings describe in each case a circular track such that the center points thereof always lie on the main axis of the convoluted bellows air spring, i.e. even in a tilted state and therefore with a curved main axis of the convoluted bellows air spring.

### BRIEF DESCRIPTION OF THE DRAWINGS

An example of the invention will be explained in more detail below on the basis of the drawing, in which:

FIGS. 1a-1c show a convoluted bellows air spring having two folds and a belt ring and an articulation according to the invention,

FIGS. 2a-2c show a convoluted bellows air spring having three folds and two belt rings with articulations according to the invention, and

FIGS. 3a-3c show a convoluted bellows air spring having kinematics according to the prior art.

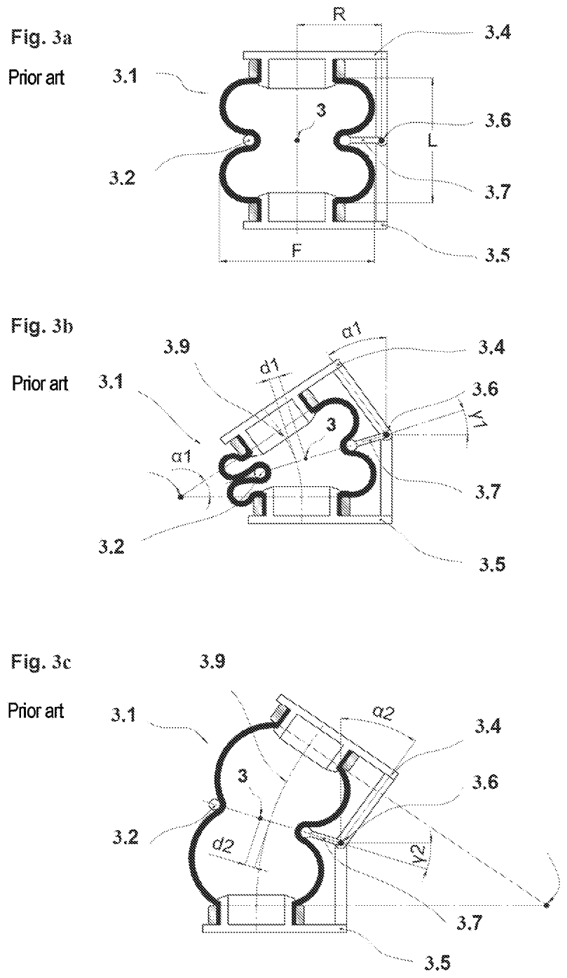

### DETAILED DESCRIPTION

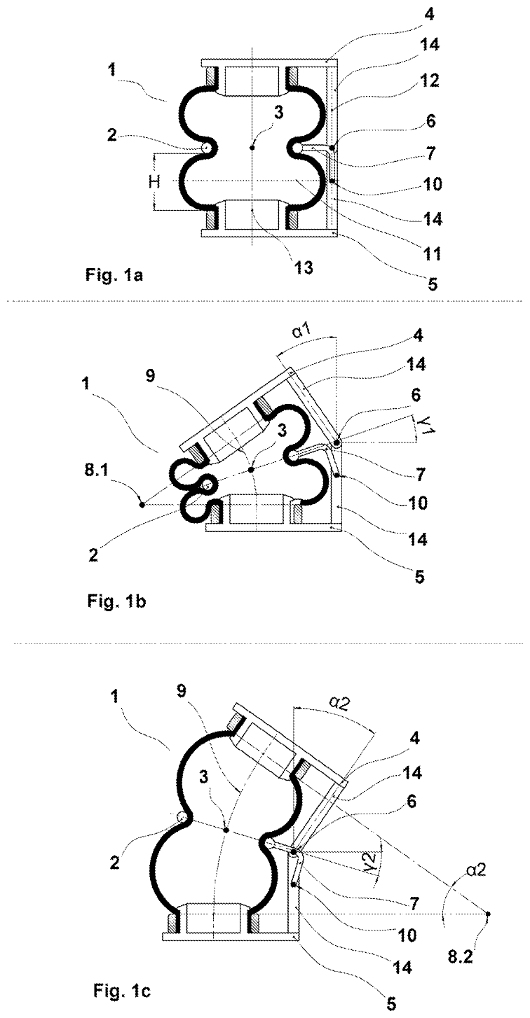

FIG. 1a shows a convoluted bellows air spring I according to the invention having a belt ring 2 in the starting position of said convoluted bellows air spring. The belt ring 2 has a center point 3, which is located here on the main axis 13 of the convoluted bellows air spring 1. The convoluted bellows air spring 1 has two connection parts, namely an upper part 4 and a lower part 5, which are firmly and airtightly connected to the respectively adjacent fold of the convoluted bellows air spring 1. The connection parts 4 and 5 are also each connected to parts to be mutually spring-mounted of an assembly, not shown specifically, which are symbolized here only in principle by a linkage 14. The assembly can be, for example, a body of a motor vehicle. Each fold of the convoluted bellows air spring 1 has a height H. The convoluted bellows air spring 1 is tiltable about a pivot axis 6. The belt ring 2 is articulated by means of a lever 7 on the assembly part assigned to the lower part 5 of the convoluted bellows air spring 1, the lever 7 being mounted rotatably about a pivot axis 10, and the pivot axis 10 being defined by the intersection of an auxiliary line 11, which runs perpendicularly to the main axis 13 in the center through the fold assigned to the lower part of the convoluted bellows air spring 1, and an auxiliary line 12, which runs parallel to the main axis 13 through the pivot axis 6 of the convoluted bellows air spring. The pivot axis 6 and pivot axis 10 are perpendicular to the drawing plane in this illustration.

FIG. 1b shows the convoluted bellows air spring I in a compressed, tilted state. The convoluted bellows air spring 1 now has a curved main axis 9. The upper part 4 and lower part 5 of the convoluted bellows air spring I now form a tilting angle α1, which is formed by the imaginary extension of the connection planes of the upper part 4 and lower part 5 at the intersection 8.1 or else by the angling of the upper part 4 relative to the vertical. For the tilting angle γ1 of the belt ring 2 relative to the original horizontal position, γ1≠½×α1 applies here, which is given by the different position of the pivot axes 6 and 10. However, the deviation of the two angles from each other is small and is compensated for by the elasticity of the folds of the convoluted bellows air spring 1.

FIG. 1c shows the convoluted bellows air spring 1 in an extended, tilted state. It now has a main axis 9, which is curved in the opposite direction to the compressed state. Here too, the upper part 4 and lower part 5 form a tilting angle α2, which is formed here by the imaginary extension of the connection planes of the upper part 4 and lower part 5 at the intersection 8.2. For the tilting angle γ2 of the belt ring 2 relative to the original horizontal position, γ2≠½×α2 also applies here, which is likewise given by the different position of the pivot axes 6 and 10. Here too, the deviation of the two angles from each other is small and is likewise compensated for by the elasticity of the folds of the convoluted bellows air spring 1.

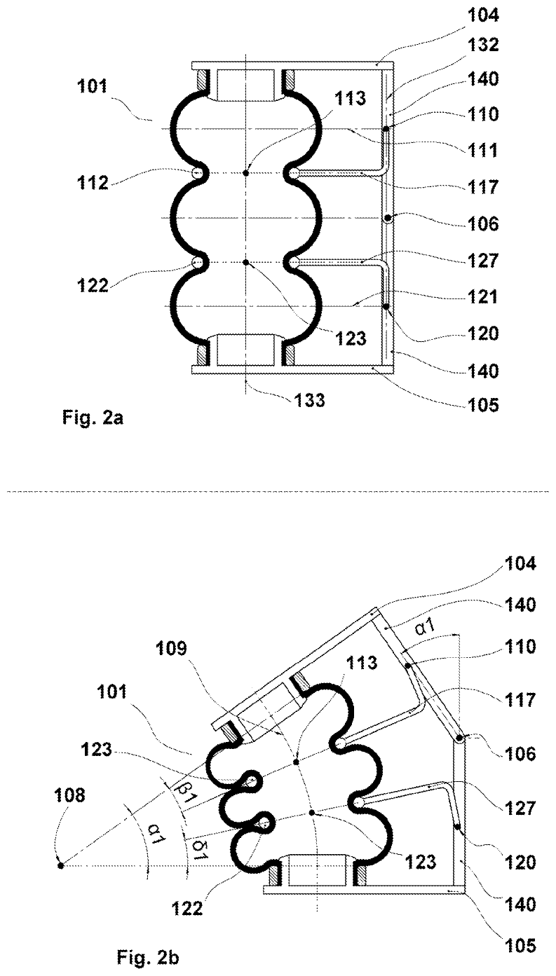

FIG. 2a shows a convoluted bellows air spring 101 according to the invention having two belt rings 112 and 122 in the starting position of said convoluted bellows air spring. The convoluted bellows air spring 101 has an upper connection part 104 and a lower connection part 105 and also a main axis 133. The upper part 104 and lower part 105 are each assigned to an assembly part to be spring-mounted, not shown specifically here, the assembly being symbolized in principle by a linkage 140. The upper part 104 and lower part 105 are tiltable relative to each other via a pivot axis 106. The belt ring 112 is articulated with a lever 117 about a pivot axis 110 on the assembly part assigned to the upper part 104. the belt ring 122 is articulated by a lever 127 about a pivot axis 120 on the assembly part assigned to the lower part 105. The pivot axes 110 and 120 are each defined by the intersection of two fictitious auxiliary lines, namely the auxiliary line 111, which runs perpendicularly to the main axis and centrally to the fold of the convoluted bellows air spring 101 assigned to the upper part 104, together with the auxiliary line 132, which runs parallel to the main axis 133 and through the pivot axis 106 of the convoluted bellows air spring 101, and the auxiliary line 121, which runs perpendicularly to the main axis and centrally to the fold of the convoluted bellows air spring 101 assigned to the lower part 105, together with the auxiliary line 132.

FIG. 2b illustrates the three-fold convoluted bellows air spring 101 according to the invention tilted by the tilting angle α1. The upper part 104 and lower part 105 of the convoluted bellows air spring 101 form a tilting angle α1, which is formed by the imaginary extension of the connection planes of the upper part 104 and lower part 105 at the intersection 108 or else by the angling of the upper part 104 relative to the vertical. The angle β1 formed between the upper part 104 and the belt ring 123 and the angle δ1 formed between the lower part 105 and the belt ring 133 are equal in size, with, however, β1≠⅓α1Λδ1≠⅓α1. Here too, this irregularity is compensated for by the elasticity of the folds of the convoluted bellows air spring 101.

### LIST OF REFERENCE SIGNS (BELONGS TO THE DESCRIPTION)

1, 101 convoluted bellows air spring
2, 112, 122 belt ring
3, 113, 123 center points of the belt rings
4, 104 upper part of the convoluted bellows air spring 1, 101
5, 105 lower part of the convoluted bellows air spring 1, 101
6, 106 pivot axis of the convoluted bellows air spring 1, 101
7, 117, 127 articulation lever
8.1, 8.2, 108 plane intersections of the connection parts
9, 109 curved main axis
10, 110, 120 pivot axes of the articulation levers
11, 111, 121 fictitious auxiliary lines perpendicular to the main axis
12, 132 fictitious auxiliary lines parallel to the main axis
13, 133 main axis of the convoluted bellows air spring 1, 101
14, 140 linkage, assembly parts

1. (canceled)

2. A convoluted bellows air spring comprising:
a plurality of folds;
one or more belt rings coupled to the plurality of folds;
an air spring pivot axis (6,106) that the air spring is tiltable about; and
one or more levers (7, 117, 127) coupled to the belt rings and each having a lever pivot axis that each tilt about and differ from the air spring pivot axis. the belt rings are articulated by a lever, the lever having a pivot axis that differs from the pivot axis of the air spring.

3. The air spring of claim 2, wherein:
the plurality of folds comprise two folds and the one or more belt rings comprise a single belt ring;
the one or more levers comprise a single lever connected to the single belt ring; and
a first auxiliary line of the two folds is perpendicular to a main axis of the air spring in an axial direction in a starting position.

4. The air spring of claim 2, wherein:
the plurality of folds comprise three folds and the one or more belt rings comprise two belt rings;
the one or more levers comprise two belt rings connected to the two belt rings; and
a first auxiliary line of the three folds is perpendicular to a main axis of the air spring in an axial direction in a starting position.

5. The air spring of claim 2, further comprising:
an upper part;
an upper fold of the plurality of folds is connected to the upper part and an upper ring of the one or more belt rings; and
an upper lever of the one or more levers is connected to the upper ring.

6. The air spring of claim 5, further comprising:
a lower part;
a lower fold of the plurality of folds is connected to the lower part and a lower ring of the one or more belt rings; and
a lower lever of the one or more levers is connected to the lower ring.

7. The air spring of claim 6, further comprising:
a linkage that couples the upper part to the lower part.
